(19) United States
(12) Patent Application Publication
(10) Pub. No.: US 2019/0266567 A1
(43) Pub. Date: Aug. 29, 2019

(54) CONSOLIDATED DELIVERY

(71) Applicant: NCR Corporation, Duluth, GA (US)

(72) Inventor: Robert Thomas Borucki, Mesa, AZ (US)

(21) Appl. No.: 15/907,099

(22) Filed: Feb. 27, 2018

(51) Int. Cl. G06Q 10/08

(52) U.S. Cl. CPC G06Q 10/08355; G06Q 10/0832

(57) ABSTRACT

Disclosed are systems and methods for consolidating deliveries. The systems and methods may include receiving a plurality of shipping requests, determining a common delivery path for transporting products to locations, and transmitting a shipping directive. Each of the plurality of shipping requests may be associated with one of the locations and one of the products. The shipping directive may be transmitted to each of a plurality of computing devices associated with a shipper or merchant. The shipping directive may include data defining the common delivery path.

### SUMMARY

Disclosed are systems and methods for consolidating deliveries. The systems and methods may include receiving a plurality of shipping requests, determining a common delivery path for transporting products to locations, and transmitting a shipping directive. Each of the plurality of shipping requests may be associated with one of the locations and one of the products. The shipping directive may be transmitted to each of a plurality of computing devices associated with a shipper or merchant. The shipping directive may include data defining the common delivery path.

### BRIEF DESCRIPTION OF THE FIGURES

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 shows an example environment consistent with this disclosure.

FIG. 2 shows an example environment consistent with this disclosure.

FIG. 3 shows an example schematic of a computing device consistent with this disclosure.

FIG. 4 shows an example method consistent with this disclosure.

Corresponding reference characters indicate corresponding parts throughout the several views. The exemplifications set out herein illustrate exemplary embodiments of the invention, and such exemplifications are not to be construed as limiting the scope of the invention any manner.

### DETAILED DESCRIPTION

The following detailed description refers to the accompanying drawings. Wherever possible, the same reference numbers are used in the drawings and the following description to refer to the same or similar elements. While embodiments and examples are described, modifications, adaptations, and other implementations are possible. For example, substitutions, additions, or modifications may be made to the elements and stages illustrated in the drawings, and the systems and methods described herein may be modified by substituting, reordering, or adding stages to the disclosed methods or elements to the discloses systems. Accordingly, the following detailed description does not limit this disclosure. Instead, the proper scope of any invention disclosed herein is defined by the appended claims.

With the progression toward driverless cars and other autonomous vehicles, many business to consumer companies are looking to automate product delivery. As the number of self-driving vehicles on the road purely for delivery increases, so too will be the risk of increased traffic and waste and pollution from inefficient planning. As disclosed herein, systems and methods may allow for orchestrated logistics across vendors and the consolidation of deliveries by segmenting location, time, and type of product.

Disclosed herein are systems and methods that may provide orchestrated logistics services for various delivery services across industries. The systems and methods may be able to identify ways to consolidate shipments to specific addresses, neighborhoods, or other locations. In addition, the systems and methods disclosed herein may manage shipments from multiple vendors. For example, when a new item needs to be delivered to an individual, a merchant may contact a system as disclosed herein via an application programming interface (API), which may check for other deliveries in the area. When other deliveries have been identified the systems and methods disclosed herein may score the compatibility of the item with the other items already scheduled for shipment. In this way, perishables, such as food, may not necessarily get delayed for delivery of non-perishables.

The systems and methods disclosed herein improve shipping and systems used in shipping items by allowing for a centrally managed delivery system to simplify, consolidate, and choreograph many-to-one deliveries. The systems and methods may also be priced per transaction and leverage integrations to existing systems (e.g. restaurant food service delivery, retail product delivery). In addition, users could advertise trips they are planning and may agree to deliver packages along their route. This would allow planned trips to be more productive and allow for a one-to-many instance. Stated another way, users could become delivery drivers and make money delivering packages on trips they would be taking anyway, and thus make the trips more productive in terms of revenue generations for the driver and less congestion/pollution on the roads.

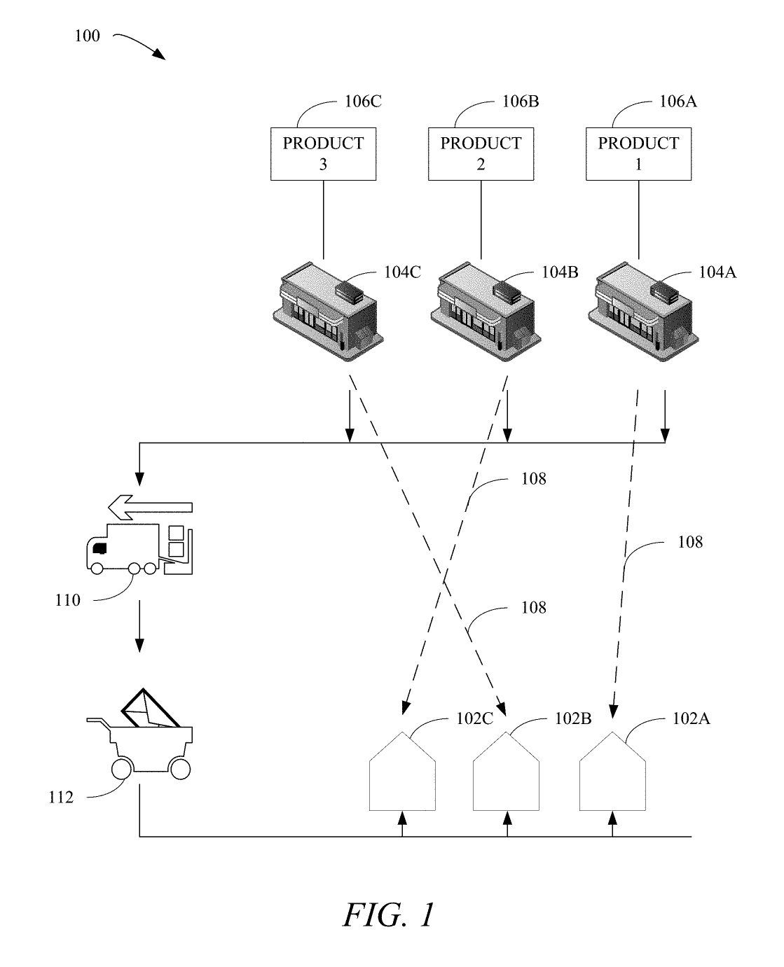

FIG. 1 shows an example environment 100 consistent with this disclosure. As shown in FIG. 1, the environment 100 may include a first location 102A, a second location 102B, and a third location 102C (collectively locations 102). The environment 100 may also include a first merchant 104A, a second merchant 104B, and a third merchant 104C (collectively merchants 104), which may sell and ship a first product 106A, a second product 106B, and a third product 106C (collectively products 106), respectively.

The locations 102 may be associated with various consumers such as businesses or individuals that may purchase the products 106. Once the products are purchased, the merchants 104 may ship the products 106 to their respective purchasers (i.e., locations 102) individually as shown by dashed lines 108. This may be inefficient because the locations 102 may be in close proximity to one another or at the same address. For example, the locations 102 may be on the same street, within the same neighborhood, or otherwise located within a predetermined distance of one another. The close proximity of the locations 102 to one another may make delivery of the products 106 by separate delivery services inefficient.

As shown in FIG. 1, a first delivery vehicle 110, may be used to deliver the products 106. The first delivery vehicle 110 may be a single delivery vehicle or may work with a second delivery vehicle 112. For example, the first delivery vehicle 110 may be a delivery vehicle associated with merchant 104A and may pick up the second product 106B and the third product 106C from the second merchant 104B and the third merchant 106C, respectively, while in route the first location 102A. Once the first delivery vehicle 110 has picked up the second product 106B and the third product 106C, the first delivery vehicle 110 may deliver them to the third location 102C and the second location 102B, respectively.

The second merchant 104B and the third merchant 104C may pay a fee to the first merchant 104A for delivering the second product 106B and the third product 106C. The fee may be a flat fee that is negotiated by the merchants 106 in advance. In addition, the fee may be based on a distance out of the way the first merchant 104A travels to deliver the second product 106B and the third product 106C. For instance, the second merchant 104B and the third merchant 104C may each pay X dollars per extra mile the first merchant 104A travels to deliver the second product 106B and the third product 106C. For example, if the distance the first merchant 104A would normally travel to deliver the first product 106A is 10 miles and the added distance to deliver the second product 106B and the third product 106C is 2 miles, the second merchant 104B and the third merchant 104C may each pay $1 per mile to have their products delivered or $2. The $2 may be split evenly a month the second merchant 104B and the third merchant 104C or it may be split on a prorated basis based on the extra distance for the second product 106B and the third product 106C, respectively. For instance, is delivering the second product 106B results in 0.5 miles added to the distance than the second merchant 104B may pay $0.50 and the third merchant 104C may pay $1.50.

As an example, the merchants 104 may be food establishments that deliver. When an order is placed the first merchant 104A may stop by the second merchant 104B and the third merchant 104C and pick up items for delivery. For instance, each of the merchants 104 may be a pizza place and a single driver may deliver pizzas for each of the pizza places to the locations 102.

As shown in FIG. 1, the first delivery vehicle 110 also may deliver the products 106 to a second delivery vehicle 112, which may then deliver the products 106 to their respective locations 102. The second delivery vehicle 112 may be associated with a common carrier such as the post office or a third party delivery company. In addition, the first delivery vehicle 110 may also be associated with a common carrier such as the post office or a third party delivery company. For example, the first delivery vehicle 110 may be a private currier that may deliver the products 106 to the post office or another private currier.

The first delivery vehicle 110 may deliver the products 106 to a central location, such as a warehouse, where the second delivery vehicle 112 may pick up the products 106. The first delivery vehicle 110 may also intercept the second delivery vehicle 112. For example, the second delivery vehicle 112 may be a postal vehicle out on a daily route delivering mail and first delivery vehicle 110 may be a commercial currier. The first delivery vehicle 110 may have products 106 that are to be delivered to locations 102, which the postal vehicle will deliver to later in the day. As such, the first delivery vehicle 110 may intercept the second delivery vehicle 112 and delivery the products 106 to the postal vehicle. The postal vehicle may then deliver the products 106 to the locations 102 later in the day.

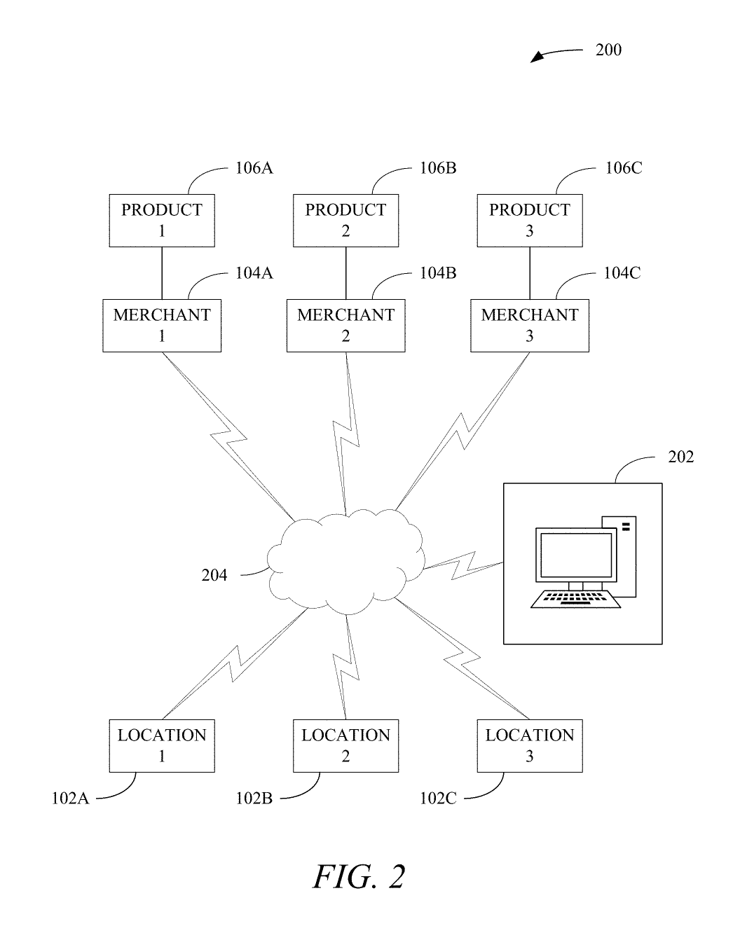

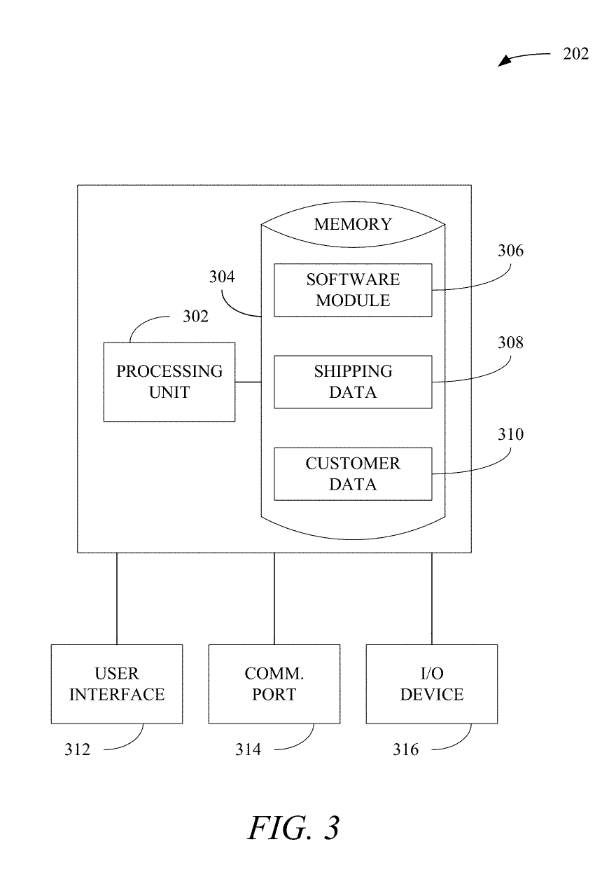

FIG. 2 shows an example environment 200 consistent with this disclosure. The environment 200 may include the locations 102 and the merchants 104. The locations 102 and the merchants 104 may be in communication with one another via a central computer 202 and a network 204. Examples of the network 202 may include, but are not limited to, the Internet, a cellular network, a local area network (LAN), a wide area network (WAN), or any combinations thereof. The central computer 202 may include a server or other computer system as described below with respect to FIG. 3.

During operations, customers located at the locations 102 may place orders for the products 106 via the central computer 202 or directly with computers located with the merchants 104 or otherwise associated with the merchants 104. As used herein, a shipper may also be a merchant since the merchant may ship the product. Once the orders for the products 106 are received, shipping or delivery information for each order may be transmitted to the central computer 202. The central computer 202 may determine an optimal delivery strategy as disclosed herein. The orders may be in the form of a shipping request. For example, the order may include a request to ship a specific product from a specific location to a specific location.

For example, the central computer 202 may use delivery addresses to group shipments bound for locations that are within a predetermined distance from one another. In addition, the central computer 202 may use the pickup address for each order and group the shipments based on where the products 106 are to be picked up. For instance, products that are being shipped from businesses within a predetermined distance (e.g., 5 miles) of each other may be grouped together so that a single delivery vehicle collects the products. The single delivery vehicle may be a third-party delivery company or a delivery vehicle associated with one of the merchants 104. For example, a delivery vehicle associated with merchant 104C may collect products 106A and 106B from the merchants 104A and 104B to be delivered.

Once the shipping requests are received, the central computer 202 may transmit a shipping directive to each of the merchants 104, or computing devices associated with each of the merchants 104. The shipping directive may include data that defines a common delivery path for transporting the products 106 to the locations 102. For example, the shipping directive may instruct the first merchant 104A to pick up the second product 106B from the second merchant 104B and deliver the products 106A and 106B to the third merchant 104C. The third merchant 104C may then deliver the products 106 to their respective delivery locations 102. In addition, the third merchant 104C may deliver the products 106 to a central location, such as a post office or other third-party delivery services, who will then in turn deliver the products 106 to their respective locations 102.

As described herein, the central computer 202 may optimize the shipping of the products 106. For instance, the central computer 202 may minimize a delivery time to deliver the products. The central computer 202 may minimize a distance traveled by one or more delivery vehicles that will deliver the products 106. The central computing device 202 may also minimize the number of delivery vehicles that may be used to deliver the products 106.

The central computer 202 may also group the shipments as disclosed herein. For example, the central computer 202 may group the products 106 into perishable and non-perishable shipments. For instance, flowers or food may be grouped as perishable and thus receive prioritized shipping. Items such books, toys, clothing, etc. may be grouped as non-perishable and be scheduled for delivery after the perishable items.

The central computer 202 also may assign priorities to each of the products 106. The priorities may be weighted and the combined weighted value may be minimized when creating the shipping directive. For example, time dependent items, such as perishable items or items being delivered for an anniversary or birthday, may have a high priority and items that are not time dependent, such as books, clothing, or other non-perishable items, by have a low priority. The weights may also be assigned based on the distance the item has to travel and length of time the delivery is outstanding. For example, an item that was ordered a week ago may be given a higher priority than an item that was ordered today. The priorities can be factored into devising the shipping directive so as to minimize the risk of a high priority item being delivered later than an expected or expiration date.

The central computer 202 may also minimize costs associated with shipping the products 106. For example, the central computer 202 may determine a total distance traveled to pick up and deliver each of the products 106. The total distance may be multiplied by a cost per mile for various shipping options to arrive at an estimated delivery costs. The costs per mile can include salary of the delivery person, fuel, automobile wear and tear, insurance, etc. Using the costs per mile, the central computing device 202 may determine that one shipping option is cheaper than other available alternatives. As a result, the central computer 202 can select the cheaper shipping option. In addition, the central computer 202 can mix and match shipping options to minimize shipping costs. For instance, the central computer 202 may use private shipping to ship the products 106 for a portion of the distance and the post office to ship the products 106 to the locations 102.

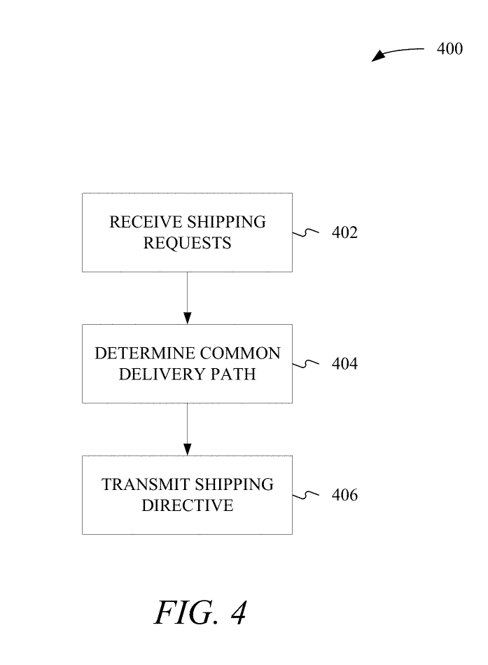

FIG. 3 shows an example schematic of the central computer 202. As shown in FIG. 3, the central computer 202 may include a processing unit 302 and a memory 304. The memory 304 may include a software module 306, shipping data 308 and customer data 310. While executing on processing unit 302, the software module 304 may perform processes for consolidating deliveries, including, for example, one or more stages included in a method 400 described below with respect to FIG. 4.

As disclosed herein, the shipping data 308 may include cost per mile data, delivery and pickup addresses, priority information for various products, available vehicles for delivery (including max gross weight, volumetric capabilities, fuel range, etc. for the vehicles). The shipping data 308 may also include information for third party shippers such as costs, availability, capacity, etc. The shipping information may also include weights and priority values for use as disclosed herein.

The customer data 310 may include billing addresses, payment information, etc. In addition, the customer data 310 may include customer profiles that allow users to customize the shipping data 308. For example, the customer data 310 may allow a user to assign a priority or maximum shipping costs to a shipment. The central computer 202 may use the priority and/or maximum shipping costs assigned by the customer to devise the shipping directive for products ordered by the customer. For instance, the customer may set a maximum shipping cost for a product, and the central computer 202 may devise a shipping directive to deliver the product in the fastest time, while not exceeding the maximum shipping cost. The customer profiles may contain proprietary information and different vendors may set permissions as to which data within the customer profiles other vendors may be able to access.

The central computer 202 may also include a user interface 312. The user interface 312 can include any number of devices that allow a user to interface with the central computer 202. Non-limiting examples of the user interface 312 include a keypad, a microphone, a display (touchscreen or otherwise), etc.

The central computer 202 may also include a communications port 314. The communications port 314 may allow the central computer 202 to communicate with various information sources, such as, but not limited to, the payment processing systems, third party shipping companies, remote computing devices associated with customers at the locations 102, etc. Non-limiting examples of the communications port 314 include, Ethernet cards (wireless or wired), Bluetooth® transmitters and receivers, near-field communications modules, etc. As disclosed herein, the communications port 314 may allow the central computer 202 to transmit the shopper's payment information to a remote payment system.

The central computer 202 may also include an input/output (I/O) device 316. The I/O device 316 may allow the central computer 202 to receive and output information. Non-limiting examples of the I/O device 316 include, a camera (still or video), a printer, a scanner, etc. For example, the I/O device 316 may include a scanner that can be used to scan barcodes on the products 106, etc. The I/O device 316 may also include a printer that can be used to print shipping labels, customer receipts, etc.

As indicated herein, the central computer 202 may be a server. The central computer 202 may located in a back room or offsite from the merchants 104. As such, the central computer 202 may be implemented using a personal computer, a network computer, a mainframe, a handheld device, a personal digital assistant, a smartphone, or any other similar microcomputer-based workstation.

FIG. 4 shows an example method 400 for consolidating delivers. The method 400 may begin at stage 402 wherein a computing device, such as the central computer 202, may receive a plurality of shipping requests from a plurality of computers (such as computers associated with the merchants 104. As disclosed herein, the shipping requests may be received in the form of orders placed to each of the merchants 104. In addition, the shipping requests may be received from a third party and the products 106 may be drop shipped from the merchants 104.

From stage 402 the method 400 may proceed to stage 404 where a common delivery path may be determined. As disclosed herein, the common delivery path may define a common path for one or more delivery vehicles to travel when picking up and delivering a plurality of products to a plurality of locations. The common delivery path may also include define pickup times and delivery times for picking up and delivering the products.

As disclosed herein, determining the common delivery path may include minimizing delivery times associated with shipping the products. For example, the central computer may retrieve traffic data and utilize the traffic data to select roads that are less congested to minimize potential delays. In addition, the traffic data may include speed limits, number of traffic lights, timing between red lights, number of stop signs, etc. and the central computer may select road with fewer traffic lights to minimize potential delays. In addition, using the timing between red lights, the central computer may determine an optimal speed for a driver to drive minimize the likely hood of having to stop at red lights. Furthermore, using traffic data the central computer may plan a delivery route that minimizing the number of left hand turns (i.e., turns across traffic) a driver may have to make to help minimize traffic delays.

In addition to or in another instance, determining the common delivery path may include minimizing a delivery distance traveled. For example, the central computer may utilize Monte Carlo methods or other stochastic methods to select routes and determine an optimal route based on the total distance traveled to pick up the products 106 from the merchants 104 and deliver them to the locations 102. As disclosed herein, minimizing the delivery distance may include minimizing a distance traveled for one of a plurality of delivery drivers/vehicles used to deliver the products 106. For instance, the distance a third-party delivery service travels may be minimized to reduce costs without regard to minimizing a delivery service of one of the merchants 104.

In addition to or in another instance, determining the common delivery path may include minimizing a number of transporters used to deliver the products 106 to the locations 102. For example, while trying to minimize costs, distance traveled, etc., the central computer may also factor in the number of transporters or delivery vehicles used to deliver the products 106. For example, using a single delivery vehicle may result in a total time to pick up and deliver the products 106 of X minutes. Using a delivery person for each product may result is a total delivery time of Y, where Y is the number of minutes each delivery person for a respective product travels added together. Y may be greater than X. Thus, there is some middle ground where multiple delivery persons may be used that has a total delivery time that is less than Y and less than X. The central computing device may determine this optimal number of delivery persons and minimum travel time. In addition to minimizing time as a function of delivery people, the central computer may minimize distance, costs, etc. as a function of delivery people. The minimization process may include simulating a plurality of routes generated randomly and selecting the route with the lowest travel time, costs, distance traveled, etc.

In addition to or in another instance, determining the common delivery path may include grouping the products into perishable and non-perishable groups. For instance, and as disclosed herein, food, flowers, and other products may be grouped as perishable and delivered with other perishable items and given priority. Items such as clothing, books, tools, toys, etc. may be grouped as non-perishable and delivered together with a lower priority.

In addition to or in another instance, determining the common delivery path may include assigning a priority to the products and minimizing a weighted average delivery time associated with shipping the products to the locations. For example, a customer may pay for priority handing and thus his or her product may be assigned a high priority. The priority assigned to the products may be used as a weighting factor used when determining distance traveled, time, costs, etc. The central computer may use the weighting factors to minimize a weighted average distance, travel time, cost, etc. when determining the common delivery path.

As disclosed herein, multiple products may be ordered from one customer that are supplied by different merchants. For example, a customer may order a pizza from one merchant and rent a DVD from another merchant. As a result, the central computer may devise a delivery path that has the pizza delivery person stop by a DVD kiosk, pick up the DVD the customer rented, and deliver both the pizza and the DVD to the customer. Because the pizza may be considered perishable and the DVD is not perishable, the delivery path may have the pizza delivery drive go get the DVD while the pizza is being prepared and then pick up the pizza so that the pizza does not get cold when the DVD is being picked up.

From stage 404 the method 400 may proceed to stage 406 where a shipping directive may be transmitted to remote computers associated with each of the merchants. For example, once the common delivery path is determined, the central computer may transmit data to each of the merchants. The data may define pickup locations for each of the products and locations where the products are to be delivered. Once the shipping directive has been transmitted, the various merchants may prepare the products and dispatch delivery persons according to the shipping directive.

### EXAMPLES

Example 1 is a method for consolidating deliveries, the method comprising: receiving, from a plurality of computing devices, a plurality of shipping requests, each of the plurality of shipping requests associated with a location and a product; determining, by a central computing device, a common delivery path for transporting the products to the locations; and transmitting, by a central computing device, a shipping directive to each of the plurality of computing devices, the shipping directive including data defining the common delivery path.

In Example 2, the subject matter of Example 1 optionally includes wherein determining the common delivery path comprises minimizing a delivery time associate with shipping the products to the locations.

In Example 3, the subject matter of any one or more of Examples 1-2 optionally include wherein determining the common delivery path comprises minimizing a delivery distance traveled in transporting the products to the locations.

In Example 4, the subject matter of any one or more of Examples 1-3 optionally include wherein determining the common delivery path comprises minimizing a number of transporters used to deliver the products to the locations.

In Example 5, the subject matter of any one or more of Examples 1-4 optionally include wherein determining the common delivery path comprises grouping the products into perishable and non-perishable groups.

In Example 6, the subject matter of any one or more of Examples 1-5 optionally include wherein determining the common delivery path comprises: assigning a priority to each of the products; and minimizing a weighted average delivery time associated with shipping the products to the locations.

Example 7 is a method for consolidating deliveries, the method comprising: receiving, from a first computing device, a first shipping request associated with a first location and a first product; receiving, from a second computing device, a second shipping request associated with a second location and a second product; determining, by a central computing device, a common delivery path for transporting the first product to the first location and the second product to the second location; and transmitting, by the central computing device, a shipping directive to the first and second computing devices, the shipping directive including data defining the common delivery path.

In Example 8, the subject matter of Example 7 optionally includes wherein the first location and the second location are a same location.

In Example 9, the subject matter of any one or more of Examples 7-8 optionally include wherein the first location and the second location are located within a predetermined distance of one another.

In Example 10, the subject matter of any one or more of Examples 7-9 optionally include wherein the first location and the second location are along a common route.

In Example 11, the subject matter of any one or more of Examples 7-10 optionally include wherein the common delivery path includes a first shipper associated with the first product shipping the first product to a second shipper associated with the second product.

In Example 12, the subject matter of any one or more of Examples 7-11 optionally include wherein the first product is shipped to a first purchaser and the second product is shipped to a second purchaser, the data defining the common delivery path including routing information for a single carrier to transport the first product to the first purchaser and the second product to the second purchaser.

In Example 13, the subject matter of any one or more of Examples 7-12 optionally include wherein determining the common delivery path comprises minimizing a delivery time associated with shipping the first product to a first purchaser and the second product to a second purchaser.

In Example 14, the subject matter of any one or more of Examples 7-13 optionally include wherein determining the common delivery path comprises minimizing a delivery distance traveled in transporting the first product to a first purchaser and the second product to a second purchaser.

Example 15 is a system for consolidating deliveries, the system comprising: a processor; and a memory storing instructions that, when executed by the processor, cause the processor to: receive, from a plurality of computing devices, a plurality of shipping requests, each of the plurality of shipping requests associated with a location and a product; determine a common delivery path for transporting the products to the locations; and transmit a shipping directive to each of the plurality of computing devices, the shipping directive including data defining the common delivery path.

In Example 16, the subject matter of Example 15 optionally includes wherein determining the common delivery path includes further instructions that, when executed by the processor, further cause the process to minimize a delivery time associate with shipping the products to the locations.

In Example 17, the subject matter of any one or more of Examples 15-16 optionally include wherein determining the common delivery path includes further instructions that, when executed by the processor, further cause the process to minimize a delivery distance traveled in transporting the products to the locations.

In Example 18, the subject matter of any one or more of Examples 15-17 optionally include wherein determining the common delivery path includes further instructions that, when executed by the processor, further cause the process to minimize a number of transporters used to deliver the products to the locations.

In Example 19, the subject matter of any one or more of Examples 15-18 optionally include wherein determining the common delivery path includes further instructions that, when executed by the processor, further cause the process to group the products into perishable and non-perishable groups.

In Example 20, the subject matter of any one or more of Examples 15-19 optionally include wherein determining the common delivery path includes further instructions that, when executed by the processor, further cause the process to: assign a priority to each of the products; and minimize a weighted average delivery time associated with shipping the products to the locations.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A method for consolidating deliveries, the method comprising:
receiving, from a plurality of computing devices, a plurality of shipping requests, each of the plurality of shipping requests associated with a location and a product;
determining, by a central computing device, a common delivery path for transporting the products to the locations; and
transmitting, by a central computing device, a shipping directive to each of the plurality of computing devices, the shipping directive including data defining the common delivery path.

2. The method of claim 1, wherein determining the common delivery path comprises minimizing a delivery time associate with shipping the products to the locations.

3. The method of claim 1, wherein determining the common delivery path comprises minimizing a delivery distance traveled in transporting the products to the locations.

4. The method of claim 1, wherein determining the common delivery path comprises minimizing a number of transporters used to deliver the products to the locations.

5. The method of claim 1, wherein determining the common delivery path comprises grouping the products into perishable and non-perishable groups.

6. The method of claim 1, wherein determining the common delivery path comprises:
assigning a priority to each of the products; and
minimizing a weighted average delivery time associated with shipping the products to the locations.

7. A method for consolidating deliveries, the method comprising:
receiving, from a first computing device, a first shipping request associated with a first location and a first product;
receiving, from a second computing device, a second shipping request associated with a second location and a second product;
determining, by a central computing device, a common delivery path for transporting the first product to the first location and the second product to the second location; and
transmitting, by the central computing device, a shipping directive to the first and second computing devices, the shipping directive including data defining the common delivery path.

8. The method of claim 7, wherein the first location and the second location are a same location.

9. The method of claim 7, wherein the first location and the second location are located within a predetermined distance of one another.

10. The method of claim 7, wherein the first location and the second location are along a common route.

11. The method of claim 7, wherein the common delivery path includes a first shipper associated with the first product shipping the first product to a second shipper associated with the second product.

12. The method of claim 7, wherein the first product is shipped to a first purchaser and the second product is shipped to a second purchaser, the data defining the common delivery path including routing information for a single carrier to transport the first product to the first purchaser and the second product to the second purchaser.

13. The method of claim 7, wherein determining the common delivery path comprises minimizing a delivery time associated with shipping the first product to a first purchaser and the second product to a second purchaser.

14. The method of claim 7, wherein determining the common delivery path comprises minimizing a delivery distance traveled in transporting the first product to a first purchaser and the second product to a second purchaser.

15. A system for consolidating deliveries, the system comprising:
a processor; and
a memory storing instructions that, when executed by the processor, cause the processor to:
receive, from a plurality of computing devices, a plurality of shipping requests, each of the plurality of shipping requests associated with a location and a product;
determine a common delivery path for transporting the products to the locations; and
transmit a shipping directive to each of the plurality of computing devices, the shipping directive including data defining the common delivery path.

16. The system of claim 15, wherein determining the common delivery path includes further instructions that, when executed by the processor, further cause the process to minimize a delivery time associate with shipping the products to the locations.

17. The system of claim 15, wherein determining the common delivery path includes further instructions that, when executed by the processor, further cause the process to minimize a delivery distance traveled in transporting the products to the locations.

18. The system of claim 15, wherein determining the common delivery path includes further instructions that, when executed by the processor, further cause the process to minimize a number of transporters used to deliver the products to the locations.

19. The system of claim 15, wherein determining the common delivery path includes further instructions that, when executed by the processor, further cause the process to group the products into perishable and non-perishable groups.

20. The system of claim 15, wherein determining the common delivery path includes further instructions that, when executed by the processor, further cause the process to:
assign a priority to each of the products; and
minimize a weighted average delivery time associated with shipping the products to the locations.
